(19) United States
(12) Patent Application Publication
(10) Pub. No.: US 2006/0294366 A1
(43) Pub. Date: Dec. 28, 2006

(54) Method and system for establishing a secure connection based on an attribute certificate having user credentials

(75) Inventors: Anthony J. Nadalin, Austin, TX (US); Bruce A. Rich, Cedar Park, TX (US); Xiaoyan Y. Zhang, Austin, TX (US)

Correspondence Address: IBM CORPORATION;INTELLECTUAL PROPERTY LAW, 11400 BURNET ROAD, AUSTIN, TX, 78758, US

(73) Assignee: International Business Machines Corp.

(21) Appl. No.: 11/165,483

(22) Filed: Jun. 23, 2005

(51) Int. Cl. H04L 9/00

(52) U.S. Cl. 713/156

(57) ABSTRACT

A method and system is presented for supporting the establishment of a secure communication session within a data processing system. A certificate request command is sent from a server to a client. A certificate command is received at the server from the client in response to the certificate request command, and the certificate command is accompanied by a public key certificate and an attribute certificate that is digitally signed by a private key that is bound to the public key certificate. A secure communication session is established in response to successfully verifying the public key certificate. The attribute certificate contains credential information for an authentication operation or an authorization operation that is performed after establishment of the secure communication session.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for multicomputer communication using cryptography.

2. Description of Related Art

E-commerce web sites and web applications perform transactions over computer networks on behalf of users. In an e-commerce web-based environment, computer systems often implement authentication and/or authorization services as a form of sentry gate prior to allowing access to protected resources within a web site. Security processes that are performed by these authentication and authorization services can be categorized within two stages.

In a first stage, a client and a server establish a secure communication session, such as an SSL (Secure Sockets Layer) session, which may include certificate and key exchanges between a client and a remote server in order to set up a trust relationship and to negotiate a cryptographic key and ciphers to be used for encrypting messages within an SSL session. Many web sites employ the SSL protocol within their authentication services. SSL, or its successor protocol, Transport Layer Security (TLS), is a widely used protocol to establish secure connections from clients to servers in order to prevent message forgery, data tampering, and eavesdropping. The SSL handshake protocol allows a client and server to negotiate an encryption algorithm and cryptographic keys before an application protocol transmits or receives its first byte of data. In this manner, the SSL handshake provides a secure communication session or connection that may be employed by higher network layers for secure communications, including a subsequent transfer of credential information for a subsequent authentication operation or a subsequent authorization operation.

In a second stage, after the secure communication session has been completed, credential information is transferred from the client to the server for a subsequent authentication operation or a subsequent authorization operation. For example, after the SSL session has been established, the server requests the client to provide user credentials, and the client provides user credentials to the server, which then verifies the user credentials in a subsequent authentication or authorization operation. Based on the verification of the user credentials, the server either allows or prevents access to protected resources by the client. There may or may not be any direct interaction with a user of the client during the first or second stage.

The two-stage procedure for establishing a secure communication session and then employing the secure communication session to transfer credential information allows a user or a client to prove its identity and/or its access privileges to an appropriate level of certainty for security purposes. However, it would be advantageous to have a method and a system that supports the establishment of a secure communication session and a subsequent transfer of credential information for a subsequent authentication or authorization operation within a single stage, which would be more efficient than a two-stage procedure.

### SUMMARY OF THE INVENTION

A method, system, apparatus, and computer program product is presented for is presented for supporting the establishment of a secure communication session within a data processing system. A certificate request command is sent from a server to a client. A certificate command is received at the server from the client in response to the certificate request command, and the certificate command is accompanied by a public key certificate and an attribute certificate that is digitally signed by a private key that is bound to the public key certificate. A secure communication session is established in response to successfully verifying the public key certificate. The attribute certificate contains credential information for an authentication operation or an authorization operation that is performed after establishment of the secure communication session.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 2 depicts a block diagram that shows a typical enterprise data processing system;

FIG. 3 depicts a dataflow diagram that shows a typical authentication process that may be used when a client attempts to access a protected resource at a server;

FIG. 4A depicts a dataflow diagram that shows multiple stages of typical information exchanges between a client and a server while including an initial stage for creating an SSL (Secure Sockets Layer) session;

FIG. 4B depicts a dataflow diagram that shows a typical client-server handshake within the SSL protocol;

FIG. 4C depicts a dataflow diagram that shows multiple stages of information exchange between a client and a server in which authentication/authorization processes occur within a single stage in accordance with the present invention;

FIG. 4D depicts a dataflow diagram that shows an enhanced client-server handshake within the SSL (Secure Sockets Layer) protocol in which the SSL handshake contains a transfer of an attribute certificate from the client to the server in accordance with an embodiment of the present invention;

FIG. 5 depicts a block diagram that shows a transfer of a CLIENT_HELLO command during an enhanced SSL handshake in accordance with an embodiment of the present invention;

FIG. 6 depicts a block diagram that shows an exemplary set of datastores and functional units that may be employed to support an enhanced SSL protocol in accordance with an implementation of the present invention;

FIG. 7 depicts a flowchart that shows a process for generating an attribute certificate that contains user/client credentials that will be transferred from a client to a server during an enhanced SSL handshake in accordance with the present invention;

FIG. 8 depicts a flowchart that shows a process for transferring an attribute certificate that contains user/client credentials from a client to a server during an enhanced SSL handshake in accordance with the present invention; and

FIG. 9 depicts a flowchart that shows a process for verifying a public key certificate and an associated attribute certificate that contains user/client credentials from a client at a server during an enhanced SSL handshake in accordance with the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

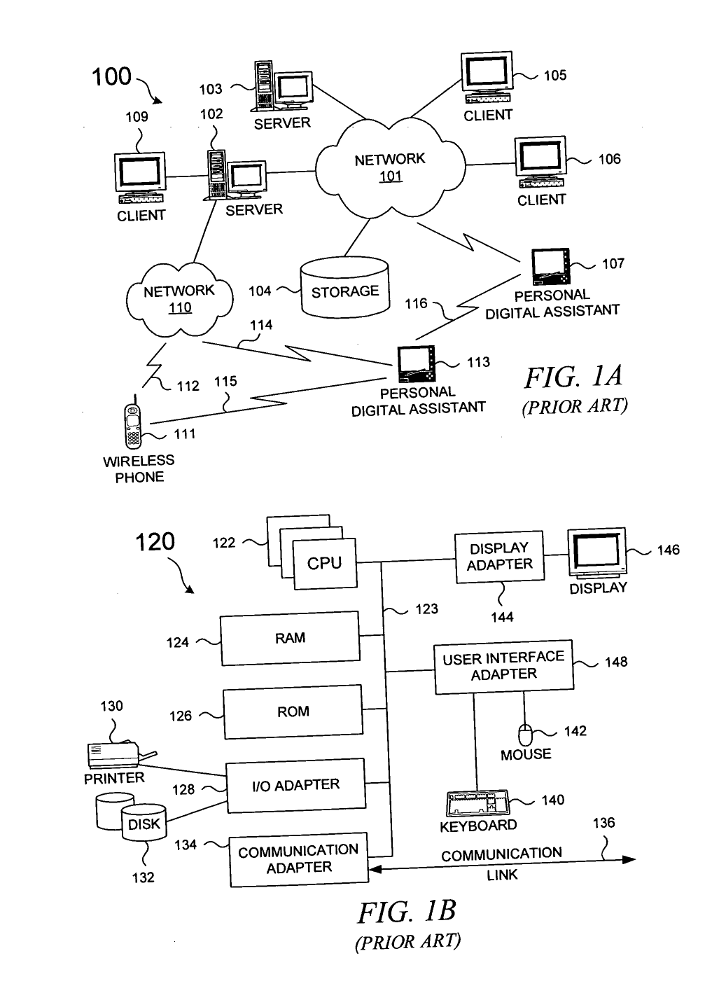

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. system bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to an improved data processing environment. Prior to describing the present invention in more detail, some aspects of typical data processing environments are described.

The descriptions of the figures herein may involve certain actions by either a client device or a user of the client device. One of ordinary skill in the art would understand that responses and/or requests to/from the client are sometimes initiated by a user and at other times are initiated automatically by a client, often on behalf of a user of the client. Hence, when a client or a user of a client is mentioned in the description of the figures, it should be understood that the terms “client” and “user” can be used interchangeably without significantly affecting the meaning of the described processes.

Certain computational tasks may be described hereinbelow as being performed by functional units. A functional unit may be represented by a routine, a subroutine, a process, a subprocess, a procedure, a function, a method, an object-oriented object, a software module, an applet, a plug-in, an ActiveX™ control, a script, or some other component of firmware or software for performing a computational task.

The descriptions of the figures herein may involve an exchange of information between various components, and the exchange of information may be described as being implemented via an exchange of messages, e.g., a request message followed by a response message. It should be noted that, when appropriate, an exchange of information between computational components, which may include a synchronous or synchronous request/response exchange, may be implemented equivalently via a variety of data exchange mechanisms, such as messages, method calls, remote procedure calls, event signaling, or other mechanism.

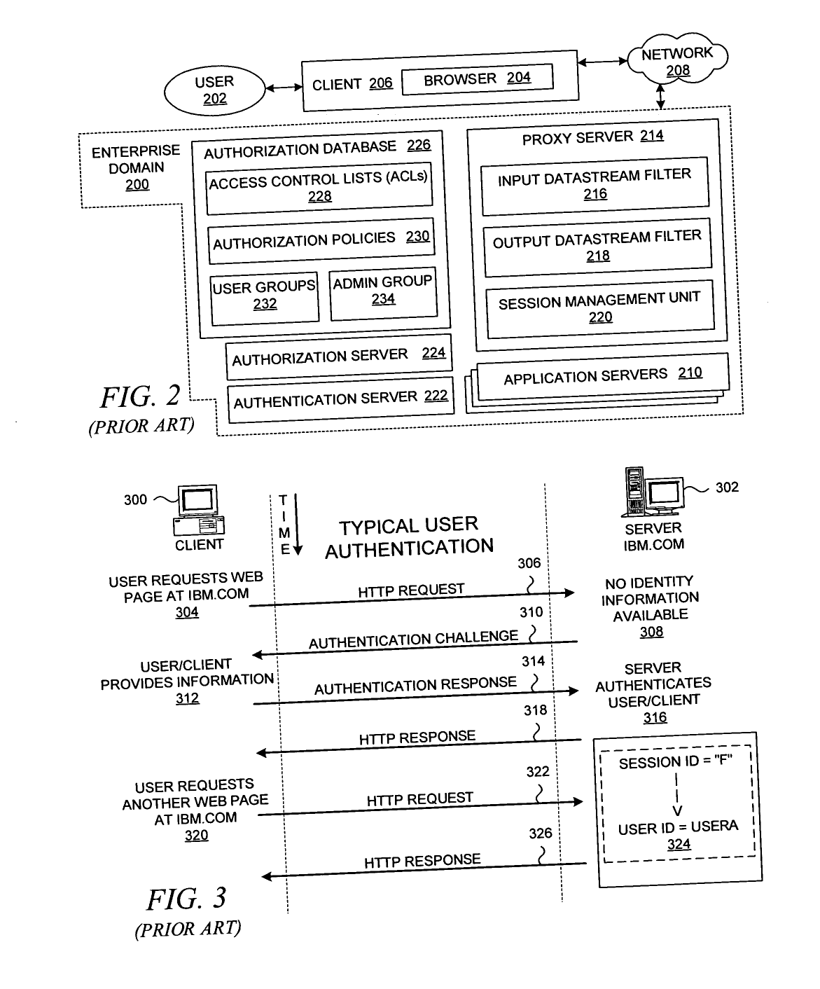

With reference now to FIG. 2, a block diagram depicts a typical enterprise data processing system. Whereas FIG. 1A depicts a typical data processing system with clients and servers, in contrast, FIG. 2 shows a client within a network in relation to some of the server-side entities that may be used to support client requests to access resources. As in a typical computing environment, enterprise domain 200 hosts resources that user 202 can access, e.g., by using browser application 204 on client 206 through network 208; the computer network may be the Internet, an intranet, or other network, as shown in FIG. 1A.

Enterprise domain 200 supports multiple servers. Application servers 210 support controlled and/or uncontrolled resources through web-based applications or other types of back-end applications, including legacy applications. Reverse proxy server 214, or more simply, proxy server 214, performs a wide range of functions for enterprise domain 200. For example, proxy server 214 may cache web pages in order to mirror the content from an application server. Incoming and outgoing datastreams may be processed by input datastream filter 216 and output datastream filter 218, respectively, in order to perform various processing tasks on incoming requests and outgoing responses in accordance with goals and conditions that are specified within various policies or in accordance with a configuration of deployed software modules.

Session management unit 220 manages session identifiers, cached credentials, or other information with respect to sessions as recognized by proxy server 214. Web-based applications typically utilize various means to prompt users to enter authentication information, often as a username/password combination within an HTML form. In the example that is shown in FIG. 2, user 202 may be required to be authenticated before client 206 may have access to resources, after which a session is established for client 206. In an alternative embodiment, authentication and authorization operations are not performed prior to providing a user with access to resources on domain 200; a user session might be created without an accompanying authentication operation.

The above-noted entities within enterprise domain 200 represent typical entities within many computing environments. However, many enterprise domains have security features for controlling access to protected computational resources. A computational resource may be an application, an object, a document, a web page, a file, an executable code module, or some other computational resource or communication-type resource. A protected or controlled resource is a resource that is only accessible or retrievable if the requesting client or requesting user is authenticated and/or authorized; in some cases, an authenticated user is, by default, an authorized user.

Authentication server 222 may support various authentication mechanisms, such as username/password, X.509 certificates, or secure tokens; multiple authentication servers could be dedicated to specialized authentication methods. Authorization server 224 may employ authorization database 226, which contains information such as access control lists 228, authorization policies 230, information about user groups or roles 232, and information about administrative users within a special administrative group 234. Using this information, authorization server 224 provides indications to proxy server 214 whether a specific request should be allowed to proceed, e.g., whether access to a controlled resource should be granted in response to a request from client 206. It should be noted that the present invention may be implemented in association with a variety of authentication and authorization applications, and the embodiments of the present invention that are depicted herein should not be interpreted as limiting the scope of the present invention with respect to a configuration of authentication and authorization services.

With reference now to FIG. 3, a data flow diagram illustrates a typical authentication process that may be used when a client attempts to access a protected resource at a server. As illustrated, the user at a client workstation 300 seeks access over a computer network to a protected resource on a server 302 through the user's web browser executing on the client workstation. A protected resource may be identified by a Uniform Resource Locator (URL), or more generally, a Uniform Resource Identifier (URI), that can only be accessed by an authenticated and authorized user.

The process is initiated when the user requests a server-side protected resource, such as a web page within the domain “ibm.com” (step 304). The terms “server-side” and “client-side” refer to actions or entities at a server or a client, respectively, within a networked environment. The web browser (or associated application or applet) generates an HTTP request that is sent to the web server that is hosting the domain “ibm.com” (step 306). The terms “request” and “response” should be understood to comprise data formatting that is appropriate for the transfer of information that is involved in a particular operation, such as messages, communication protocol information, or other associated information.

The server determines that it does not have an active session for the client (step 308), so the server requires the user to perform an authentication process by sending the client some type of authentication challenge (step 310). The authentication challenge may be in various formats, such as an HTML form. The user then provides the requested or required information (step 312), such as a user identifier and an associated password, or the client may automatically return certain information, such as a digital certificate.

The authentication response information is sent to the server (step 314), at which point the server authenticates the user or client (step 316), e.g., by retrieving previously submitted registration information and matching the presented authentication information with the user's stored information. Assuming the authentication is successful, an active session is established for the authenticated user or client.

The server then retrieves the requested web page and sends an HTTP response message to the client (step 318). At that point, the user may request another page within “ibm.com” (step 320) within the browser by clicking a hypertext link, and the browser sends another HTTP request message to the server (step 322). At that point, the server recognizes that the user has an active session based on session state information that is maintained by the server (step 324). For example, the server recognizes the appropriate session state information for the requesting user because the user's client returns a session ID within the HTTP Request message. Based on the cached user session information, the server determines that the user has already been authenticated, e.g., by the availability of a copy of the user's credentials; the server can then determine that certain operations, such as an authentication operation, is not required to be performed prior to fulfilling the user's request. The server sends the requested web page back to the client in another HTTP response message (step 326), thereby fulfilling the user's original request for the protected resource.

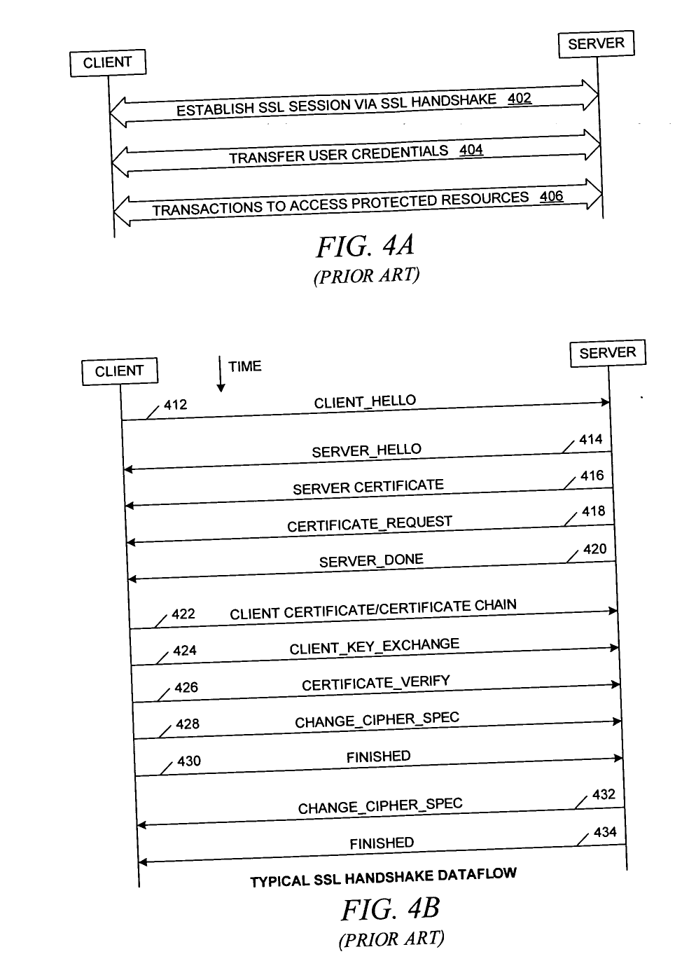

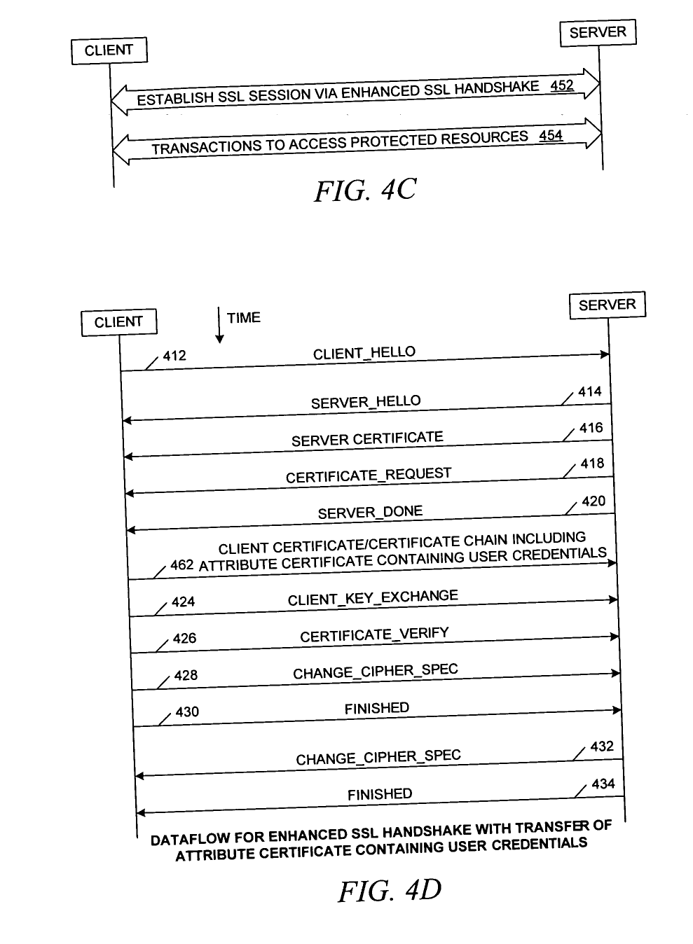

Although FIG. 3 depicts a typical authentication process that may be used when a client attempts to access a protected resource at a server, FIG. 3 does not provide detail for a secure process that ensures that the authentication process is performed in a confidential manner between a client and a server. In contrast, FIG. 4A illustrates a process for securing information exchanges between a client and a server so that subsequent data exchanges, such as an authentication/authorization process and further requests to access protected resources, can be performed in a confidential manner.

With reference now to FIG. 4A, a dataflow diagram depicts multiple stages of typical information exchanges between a client and a server while including an initial stage for creating an SSL (Secure Sockets Layer) session. Authentication/authorization processes that are performed by an enterprise domain's authentication services can be categorized within two typical stages. In a typical first stage 402, a client and a server engage in an SSL (Secure Sockets Layer) handshake, which may include certificate and key exchanges in order to set up a trust relationship and to negotiate a cryptographic key and ciphers to be used for encrypting messages within an SSL session. There may or may not be any direct interaction with a user of the client during this first stage, particularly with respect to error processing.

In a typical second stage 404, after the SSL handshake has been completed, the server requests the client to provide user credentials, and the client provides user credentials to the server. Based on the verification of the user credentials, the server either disconnects the client or continues the secure connection with the client for further data exchanges. There may or may not be any direct interaction with a user of the client during this second stage, particularly with respect to error processing. Thereafter, the client and the server engage in typical transactions 406 during which the server responds to the client's requests to access protected resources.

With reference now to FIG. 4B, a dataflow diagram depicts a typical client-server handshake within the SSL protocol, e.g., as may be performed during a typical first stage of authentication/authorization operations as shown in FIG. 4A. The SSL protocol supports an exchange of information between a client and a server such that subsequent information exchanges can be performed confidentially within an SSL session. An SSL session always begins with an exchange of messages called an SSL handshake. During an SSL handshake, a client and a server negotiate a cryptographic algorithm and exchange asymmetric cryptographic keys to produce a symmetric cryptographic key, called a session key. Thereafter, the session key is used to encrypt information exchanges. A session key may be assumed to be unique to the session in which it was created, thereby ensuring that the information exchanges during that session are confidential.

In this manner, SSL uses a combination of public-key encryption and symmetric-key encryption. The SSL handshake allows the server to authenticate itself to the client by using public-key techniques. It then allows the client and server to cooperate in creating symmetric key/keys that is/are used for encryption, decryption, and tamper detection during the SSL session that follows. Public-key encryption provides more effective authentication techniques, which is desirable for generating the session key, while symmetric-key encryption is faster than public-key encryption, which is desirable during the transactions in which a client is requesting access to protected resources and a server is responding to those requests. FIG. 4B illustrates a typical SSL handshake by explaining a typical sequence of commands that occur when messages are exchanged during an SSL handshake. More specifically, FIG. 4B illustrates a common SSL handshake—SSL version 3 and TLS version 1 handshake flow with client authentication for a new session. It should be noted that multiple SSL records could be sent in a single packet.

The process commences when the client sends a CLIENT_HELLO command to the server (step 412). The CLIENT_HELLO command includes: the highest SSL and TLS version supported by the client (it may be assumed that the client supports earlier versions in a backward-compatible manner); ciphers supported by the client and listed in the order of preference; data compression methods that are supported by the client; the session ID, which is equal to zero if the client is starting a new SSL session; random data that is generated by the client for use in the key generation process. The cipher suites are a list of encryption algorithms the client supports, such as RSA with 3DES or RSA with IDEA. The client provides a complete list of the ciphers it is able or willing to support so that the server may choose one. The list of compression algorithms is meant to function much like the list of cipher suites in which the client provides a list of what it can do and the server is meant to pick one. The session ID can be used to indicate the client wants to resume a previously negotiated session; the advantage to this is time is saved by not negotiating a new session key, although the client will usually send a session ID of zero to indicate a new session must be negotiated. The random data, known as a “nonce”, is one of the variables that is used in generating the session key and also prevents replay attacks.

In response, the server sends multiple commands. The server sends a SERVER_HELLO command to the client (step 414). The SERVER_HELLO command includes: the SSL or TLS version that will be used for the SSL session; the cipher that will be used for the SSL session; the data compression method that will be used for the SSL session; the session ID for the SSL session; random data that is generated by the server for use in the key generation process. The random data or nonce is a random value generated by the server that is used in the same fashion as the client's nonce. The session ID, cipher suite, and compression method are all values chosen by the server and imposed onto the client; the client has previously indicated the values that it can support, and the server chooses among the available options. If the server is not willing or able to support the client for whatever reason, the server aborts the handshake and closes the connection.

The server also sends a CERTIFICATE command to the client (step 416). The CERTIFICATE command is accompanied by the server's public key certificate and, optionally, a chain of digital certificates beginning with the digital certificate of the certificate authority (CA) that issued the server's public key certificate. In addition, the server sends a CERTIFICATE_REQUEST command to the client (step 418) to request the client certificate. The CERTIFICATE_REQUEST command contains the names of the certificate authorities that the server trusts so that the client can provide a certificate signed by one of those certificate authorities. The server then sends the SERVER_DONE command to the client (step 420). The SERVER_DONE command indicates that the server has completed this phase of the SSL handshake.

Prior to responding to the server's commands, the client may perform several verification steps. For example, after the client has received the server's certificate or certificate chain, the client may take a few steps to validate the certificate. The client can check the subject name on the certificate and compare it to the domain name that has been used to connect to the server. If the names do not match, the client can abort the handshake. The client can also check the valid dates on the certificate to ensure that the certificate has not expired. The client can also attempt to validate the digital signature on the server's certificate, assuming that the client trusts the issuer. If the client cannot validate the certificate, the client can abort the handshake. In some cases, the client may allow the user of the client to determine whether or not to abort the handshake by informing the user that an error has been detected and then allowing the user to choose whether to continue.

In response to receiving the server's commands, the client sends multiple commands. The client sends a CERTIFICATE command to the server (step 422), which is accompanied by the client's public key certificate and, optionally, a chain of digital certificates beginning with the digital certificate of the certificate authority that issued the client's public key certificate. The client also sends a CLIENT_KEY_EXCHANGE command to the server (step 424). This CLIENT_KEY_EXCHANGE command contains the premaster secret (PreMasterSecret) that was created by the client. The premaster secret is protected by encrypting it using the server's public key from the server's digital certificate; if the server is the legitimate owner of the digital certificate that it previously sent, then only the server should possess the private key that is necessary to decrypt the premaster secret. Both the client and the server separately generate the symmetric encryption key/keys using the premaster secret and the random data that accompanies the SERVER_HELLO and CLIENT_HELLO commands. If the server is actually an attacker posing as the owner of the digital certificate, it will be unable to decrypt the premaster secret, which means it will be unable to derive the session key; without the session key, the server is unable to complete the handshake because of the validation step associated with the FINISHED command, which is described hereinbelow.

The client also sends a CERTIFICATE_VERIFY command to the server (step 426). The CERTIFICATE_VERIFY command includes a digest of the SSL handshake messages that have been signed using the client's private key. The server calculates its own digest and uses the client's public key, which has been obtained from the client's digital certificate, to verify the digest sent by the client, hereby completing an authentication procedure to verify that the client possesses the corresponding private key for the public key from the client's digital certificate. The client also sends a CHANGE_CIPHER_SPEC command to the server (step 428). The CHANGE_CIPHER_SPEC command indicates that the contents of subsequent SSL record data sent by the client to the server during the SSL session will be encrypted; SSL record headers, however, are not encrypted. The client concludes by sending the FINISHED command to the server (step 430). The FINISHED command is encrypted with the session key and includes a digest of all the SSL handshake commands that have flowed between the client and the server up to this point. This command is sent to validate that none of the commands sent previously, which flow between the client and the server unencrypted, were altered in transmission, e.g., by a malicious user employing a so-called man-in-the-middle or replay attack. The nonce values sent in the CLIENT_HELLO and SERVER_HELLO messages help to ensure that the handshake messages from different SSL sessions are different, even if the sessions are between the same client and server. Without the nonce values, it may be possible under certain circumstances for an attacker to capture the handshake messages between the client and server and replay them later in an attempt to spoof one side.

In response to the client's commands, the server then sends a CHANGE_CIPHER_SPEC command to the client (step 432). This command indicates that all subsequent data sent by the server during the SSL session will be encrypted. The server concludes by sending a FINISHED command to the client (step 434), which is encrypted with the session key and includes a digest of all the SSL handshake commands that have flowed between the server and the client up to this point; the FINISHED command acts as a notification message that the SSL session has been successfully established, thereby concluding the typical SSL handshake process.

Given the background information that is discussed with respect to FIG. 1A-4B, the description of the remaining figures relates to the present invention. It should be noted that there are multiple versions of the SSL protocol or the TLS protocol and that the present invention is applicable or intended to be applicable to multiple versions of the SSL protocol or the TLS protocol, including past, current, and future versions. Hence, although the exemplary embodiments are herein described as an enhanced SSL handshake, the exemplary embodiments could be described as an enhanced TLS handshake. Moreover, the examples herein describe information transfers between a client and a server using typical HTTP/HTTPS message exchanges to transfer web pages between web-based applications, including web browsers. It should be noted also that the present invention is applicable to a wide variety of communication protocols that use and/or support the SSL protocol and in a wide variety of data processing environments that are not web-centric.

With reference now to FIG. 4C, a dataflow diagram depicts multiple stages of information exchange between a client and a server in which authentication/authorization processes occur within a single stage in accordance with the present invention. FIG. 4C is similar to FIG. 4A in that both figures illustrate at least one authentication/authorization stage and a subsequent transaction stage. However, whereas FIG. 4A contains multiple authentication/authorization stages, FIG. 4C illustrates only one authentication/authorization stage.

More specifically, FIG. 4C differs from FIG. 4A in that FIG. 4C illustrates an initial stage 452 that is an information exchange that includes an enhanced SSL handshake. Within stage 452, the enhanced SSL handshake supports the retrieval of user credentials from the client by the server, as discussed in more detail hereinbelow. Based on the verification of the user credentials, the server either disconnects the client or continues the secure connection with the client for further data exchanges. Thereafter, the client and the server engage in a subsequent transaction stage 454 during which the server responds to the client's requests to access protected resources.

With reference now to FIG. 4D, a dataflow diagram depicts an enhanced client-server handshake within the SSL (Secure Sockets Layer) protocol in which the SSL handshake contains a transfer of an attribute certificate from the client to the server in accordance with an embodiment of the present invention. FIG. 4D is similar to FIG. 4B in that both figures illustrate a handshake procedure for establishing an SSL session; identical reference numerals refer to identical steps or commands.

However, whereas FIG. 4B illustrates a typical SSL handshake, e.g., as might be used during the first stage of a multistage authentication/authorization procedure as shown in FIG. 4A, FIG. 4D illustrates an enhanced SSL handshake, which, in an embodiment of the present invention, might be used during a single stage authentication/authorization procedure as shown in FIG. 4C. In other words, rather than employing a typical two-stage authentication/authorization procedure in which an SSL session is established in a first stage and user credentials are transferred and verified during a second stage within the previously established SSL session, the present invention presents a single-stage authentication/authorization procedure that employs an enhanced SSL handshake that supports the transfer and verification of user credentials within the single stage.

FIG. 4D differs from FIG. 4B in that step 422 in FIG. 4B has been replaced with step 462. In a manner similar to step 422, when the client responds to the CERTIFICATE_REQUEST command from the server, the client at step 462 sends a CERTIFICATE command that is accompanied by the client's digital certificate and, optionally, a chain of digital certificates beginning with the digital certificate of the certificate authority that issued the client's public key certificate.

Step 462 differs from step 422 because the client's digital certificate (and, optionally, digital certificate chain) at step 462 is additionally accompanied by an attribute certificate that has been issued in accordance with the client's digital certificate. The attribute certificate contains credentials for the client/user for performing an additional authentication or authorization operation, e.g., above the SSL layer within the application layer, thereby transferring additional credentials within the enhanced SSL handshake such that a subsequent transfer of the credentials is unnecessary, as explained in more detail hereinbelow.

The attribute certificate can be considered to be part of the client's certificate chain. The attribute certificate can be verified using the client's public key in the client's digital certificate since the client's private key would have been used to sign the attribute certificate. In a well-known manner of verifying a certificate chain, the verification procedure may also involve usage of other digital certificates within the client's certificate chain if transferred and/or necessary for the level of security that is implemented in the verification procedure.

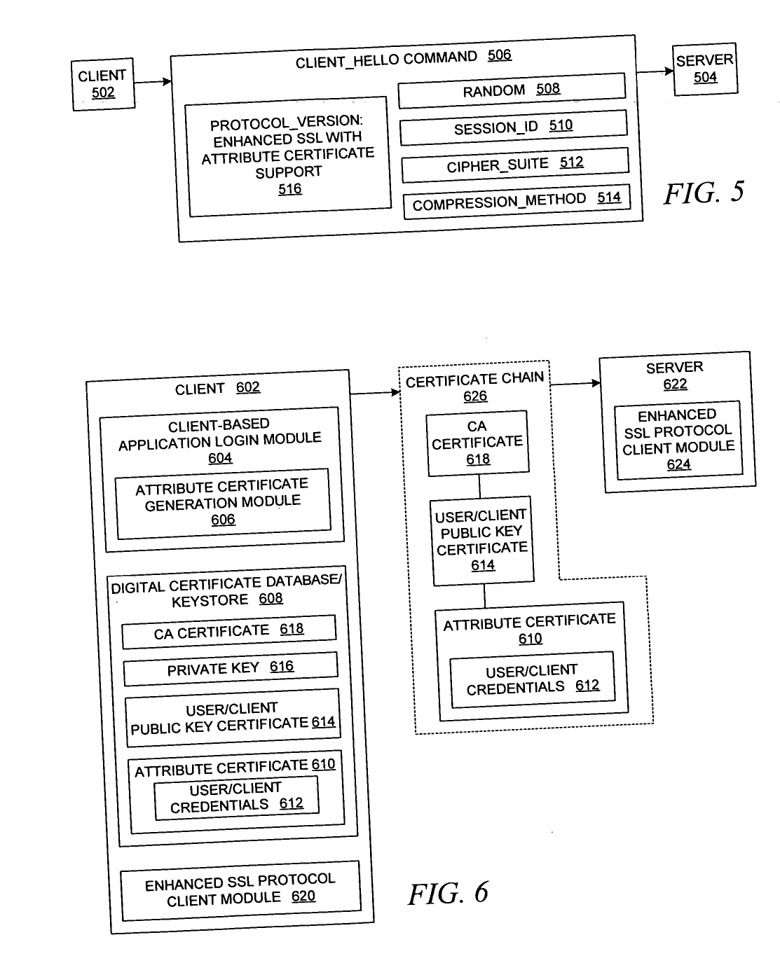

With reference now to FIG. 5, a block diagram depicts a transfer of a CLIENT_HELLO command during an enhanced SSL handshake in accordance with an embodiment of the present invention. Referring again to FIG. 4D, as noted above, an implementation of the present invention includes additional information at step 462 when a client sends a certificate chain to a server during an enhanced SSL handshake. It should be noted that, in alternative implementations of the enhanced SSL handshake of the present invention, the content of the CLIENT_HELLO command at step 412 and the SERVER_HELLO command at step 414 may also contain enhanced information that would not be used within a typical SSL handshake.

Referring now to FIG. 5, client 502 sends CLIENT_HELLO command 504 to server 506, and CLIENT_HELLO command 504 contains some typical data fields: random data 508, session identifier 510, cipher suite data 512, and compression method data 514. Although a PROTOCOL_VERSION data field in a typical CLIENT_HELLO command would indicate the highest SSL and TLS version supported by the client, an exemplary implementation of the present invention may include within CLIENT_HELLO command 504 a novel data value 516. In an embodiment of the present invention, data value 516 within the PROTOCOL_VERSION data field may correspond to an enhanced SSL protocol version in which an attribute certificate is exchanged, thereby indicating that the client is able to support the transfer of credentials within an attribute certificate during the enhanced SSL handshake. In a corresponding manner, the SERVER_HELLO command that the server returns to the client (not shown) may also contain the enhanced SSL protocol version indicator value.

With reference now to FIG. 6, a block diagram depicts an exemplary set of datastores and functional units that may be employed to support an enhanced SSL protocol in accordance with an implementation of the present invention. As discussed above with respect to FIG. 4D, a client includes additional information when sending a certificate or a certificate chain to a server during an enhanced SSL handshake; more specifically, the client's digital certificate/certificate chain is accompanied by an attribute certificate that has been issued using the client's digital certificate and that includes additional security credentials in some format. Prior to performing an enhanced SSL handshake in accordance with the present invention, the client and the server need to be configured to provide support for the enhanced SSL handshake. FIG. 6 illustrates some of the elements that might be used to configure a client and a server to perform the operations that support the enhanced SSL handshake.

Client 602 supports client-based application login module 604, which contains attribute certificate generation module 606. The form factor of client-based application login module 604 may vary in different implementations of the present invention. For example, client-based application login module 604 may be statically contained within a stand-alone application or an administrative utility, or client-based application login module 604 may be dynamically downloaded from a server. Client-based application login module 604 may be a Java™ Authentication and Authorization Service (JAAS) module; JAAS is a package that enables services to authenticate and/or enforce access controls upon users. In any case, various security measures may be required to operate client-based application login module 604, e.g., administrative personnel privileges or specific privileges that are possessed by a given user.

At an appropriate time, a user of the client operates client-based application login module 604, and client-based application login module 604 obtains credential information that forms the basis of the user's credentials; for example, the client may be configured to retrieve the credential information from a particular directory or database, or the user might be prompted to enter a source location or to perform some other input operation. The format of the credential information may vary for many different types of authentication/authorization operations. For example, the user might be prompted to enter a username-password value pair, or the user may be prompted to perform an action that allows biometric data to be obtained from the user. Alternatively, the credentials may be represented by a Kerberos ticket that is retrieved from an appropriate database, such as digital certificate database/keystore 608, which may be a secure datastore in which access is protected in some manner, e.g., by a master password or an additional biometric procedure.

Client-based application login module 604 retrieves the credential information and generates attribute certificate 610 that contains credential information 612. Additional information may also be bundled into attribute certificate 610, such as the domain name for which the attribute certificate is intended to be used. As part of the issuance process, attribute certificate 610 is signed using the appropriate private key, e.g., private key 616 that corresponds to, i.e. that is associated with or that is bound to, public key certificate 614. Attribute certificate 610 may be stored within an appropriate database until a later point in time when it is needed, such as certificate database/keystore 608, which contains other certificates in the associated user/client certificate chain, e.g., user/client certificate 614 and CA certificate 618, which is the public key certificate of the certificate authority that issued user/client certificate 614.

In effect, client 602 is acting as a certificate authority to issue attribute certificate 610, which contains attribute information to be associated with, i.e. attributed to, an entity, i.e. the client or the user, whose identity is bound to the private key and the corresponding digital certificate. Whereas a public key certificate provides a binding between an identity and a public key, an attribute certificate provides a binding between an identity and attribute information for that identity. The digital signature on the attribute certificate using the private key ties the attribute certificate to the public key certificate that corresponds to the private key.

The usage of generalized attribute certificates is well-known. The present invention is compatible with a variety of formats for public key certificates and attribute certificates. In an exemplary embodiment, the public key certificates may be formatted as described in Housley et al., “Internet X.509 Public Key Infrastructure Certificate and Certificate Revocation List (CRL) Profile”, RFC 3280 (Request for Comments 3280), Internet Engineering Task Force (IETF), April 2002. Likewise, the attribute certificates may be formatted as described in Farrell et al., “An Internet Attribute Certificate Profile for Authorization”, RFC 3281, IETF, April 2002.

At some later point in time, client 602 employs enhanced SSL protocol client module 620 to interact with server 622 to perform an enhanced SSL handshake in accordance with the present invention; server 622 supports corresponding enhanced SSL protocol server module 624 for performing its actions with respect to the enhanced SSL handshake. In response to a CERTIFICATE_REQUEST command from server 622, client 602 sends certificate chain 626 to server 622. Certificate chain 622 contains user/client public key certificate 614 and attribute certificate 610, and, optionally, additional certificates that form the certificate chain for certificate 614. After receiving certificate chain 626, server 622 can verify certificate 614 and the credentials within attribute certificate 610. Certificate chain 626 or portions thereof, such as the credential information that is embedded within the attribute certificate or the entire attribute certificate, may be encrypted with the server's public key by client 602 prior to transmission in order to protect the confidentiality of credential information 612.

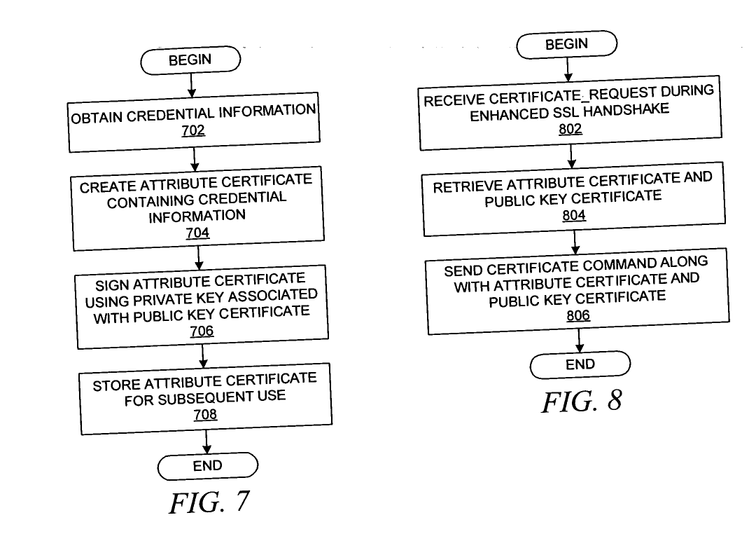

With reference now to FIG. 7, a flowchart depicts a process for generating an attribute certificate that contains user/client credentials that will be transferred from a client to a server during an enhanced SSL handshake in accordance with the present invention. The process commences at the client by obtaining credential information (step 702), e.g., from the user or a data repository. The attribute certificate is created containing the credential information (step 704). The credential information is stored within a data field inside the attribute certificate; the format of the credential information may vary, but the credential information may be text data, ASCII-encoded hexadecimal data, or some other format. If the credential includes a plain-text password, the password can be protected using various mechanisms. For example, the password can be encrypted using the public key from the server's certificate or using a temporary RSA key provided in a server key exchange message. Alternatively, a hash algorithm, such as SHA or MD5, may be used to hash the password, and the hash value would be transferred instead of the actual password.

The attribute certificate is then signed with the private key from the appropriate public key certificate (step 706). The attribute certificate is then stored in an appropriate datastore for subsequent use (step 708), preferably within a local database at the client, and the process is concluded.

With reference now to FIG. 8, a flowchart depicts a process for transferring an attribute certificate that contains user/client credentials from a client to a server during an enhanced SSL handshake in accordance with the present invention. In the example that is shown in FIG. 8, an enhanced SSL handshake has already been initiated before the initial step of the illustrated process, so the process that is shown in FIG. 8 depicts only part of an entire enhanced SSL handshake. The process commences when the client receives a CERTIFICATE_REQUEST command from a server during an enhanced SSL handshake (step 802). The client retrieves an attribute certificate and public key certificate from an appropriate datastore (step 804) and sends them in a CERTIFICATE command to the server (step 806), thereby concluding the process.

In the example that is illustrated in FIG. 8, the attribute certificate is retrieved from a datastore at step 804; for example, the attribute certificate may have been previously created using a process such as that shown in FIG. 7. In an alternative embodiment, the attribute certificate could be dynamically generated at step 804 using a process similar to that shown in FIG. 7 rather than retrieving a previously created attribute certificate. For example, in one embodiment, the credential information that is embedded within the attribute certificate may be encrypted using a server's public key that is received by the client from the server during the enhanced SSL handshake protocol; in that case, the attribute certificate would be dynamically generated after the server's public key is received. However, in another embodiment, the entire attribute certificate or the entire certificate chain is encrypted prior to transmission from the client to the server, in which case the attribute certificate could be either retrieved from a datastore at step 804 or dynamically generated at a similar point within the process prior to performing any appropriate encryption operations.

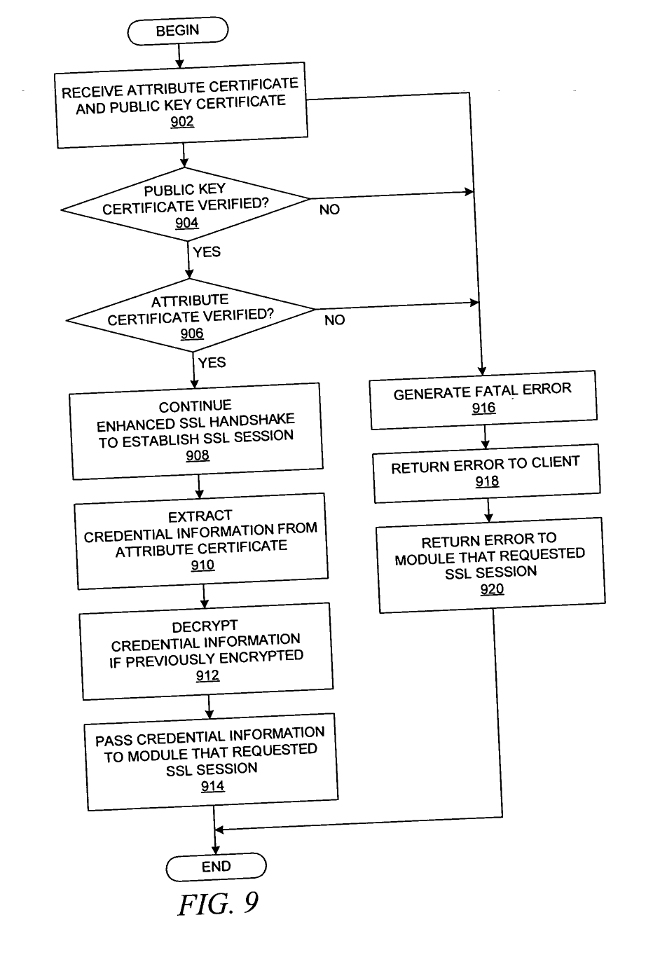

With reference now to FIG. 9, a flowchart depicts a process for verifying a public key certificate and an associated attribute certificate that contains user/client credentials from a client at a server during an enhanced SSL handshake in accordance with the present invention. An enhanced SSL handshake has already been initiated before the initial step of the illustrated process, so the process that is shown in FIG. 9 depicts only part of an entire enhanced SSL handshake.

The process commences when the server receives an attribute certificate and public key certificate in a CERTIFICATE command from the client (step 902). The server attempts to verify the public key certificate (step 904), and if successful, the server also attempts to verify the associated attribute certificate (step 906); if the public key certificate and the associated attribute certificate are both successfully verified, then the enhanced SSL handshake is continued in order to establish an SSL session (step 908).

It should be noted that the present invention may be implemented such that the public key certificate and the attribute certificate are not necessarily verified by the same software module at the server nor within the same network layer that may be ascribed to the verifying software modules. In the example that is shown in FIG. 9, the public key certificate and the attribute certificate are verified while the SSL session is being established in accordance with the enhanced SSL handshake protocol; if the attribute certificate fails to be verified, the SSL session fails to be established. Alternatively, the attribute certificate could be verified after the SSL session has been established with the enhanced SSL handshake protocol; in this manner, the SSL session could be established yet the attribute certificate could still be rejected, thereby enabling the SSL session to continue to be used.

Similarly, it should be noted that the present invention may be implemented such that the attribute certificate and its contained credential information are not necessarily verified by the same software module at the server nor within the same network layer that may be ascribed to the verifying software modules. In the example that is shown in FIG. 9, the attribute certificate is verified while the SSL session is being established in accordance with the enhanced SSL handshake protocol, after which the credential information is passed in some manner to a calling module that expects the credential information to be returned. More specifically, the credential information is extracted from the attribute certificate (step 910). The credential information is then passed to a calling module that is expecting the credential information to be returned (step 912), and the process is concluded. It would be expected that the requesting module would thereafter verify the credential information. In this manner, the SSL session is established using the enhanced SSL handshake protocol with the result that credential information is returned to the module that has requested the establishment of the SSL session.

A preferred embodiment is shown in FIG. 9 such that the credential information is verified after the establishment of the SSL session such that the logic for handling the credential information is not embedded in the SSL layer but rather at a higher layer, such as the application layer. With the illustrated embodiment of the present invention, a secure communication session is created while transferring credential information within a single stage operation such that the credential information is available for a subsequent authentication procedure or a subsequent authorization procedure, i.e. after the establishment of the secure communication session.

In an alternative embodiment, though, the present invention may be implemented such that the attribute certificate and its contained credential information are verified while the SSL session is being established in accordance with the enhanced SSL handshake protocol. In this alternative embodiment, the enhanced SSL handshake may experience a fatal error if the credential information also fails to be verified; in other words, the public key certificate, the attribute certificate, and its contained credential information would be required to be verified to establish an SSL session in accordance with this alternative implementation of the enhanced SSL handshake protocol.

In yet another alternative embodiment, rather than returning only the credential information to the module that has requested the establishment of the SSL session, the entire attribute certificate could be returned, thereby providing the attribute certificate along with the credential information that is embedded within the attribute certificate.

Decryption operations can be performed as necessary. If the credential information was previously encrypted before being embedded within the attribute certificate, e.g., by the client using the server's public key, then the credential information is decrypted at the server, e.g., with the server's private key. If the entire attribute certificate and/or the entire certificate chain was previously encrypted by the client prior to transmission to the server, then the entire attribute certificate and/or the entire certificate chain would be decrypted at the server at appropriate points within the process that is illustrated in FIG. 9.

The present invention may also be implemented to provide error handling with respect to a failure to establish an SSL session in accordance with the enhanced SSL session. If either the public key certificate or the attribute certificate fails to be verified, then a fatal error is generated (step 914), which terminates the enhanced SSL handshake. An error message may be sent by the server to the client (step 916). An error may be returned to the module that had requested the establishment of the SSL session (step 918). In any case in which a fatal error is generated, the SSL session is not established, and the process is concluded.

In the example that is shown in FIG. 9, an attempt is made to verify the attribute certificate while attempting to establish the SSL session; hence, if the attribute certificate fails to be verified, the SSL session fails to be established. As noted above, however, in an alternative embodiment, the attribute certificate could be verified after the SSL session has been established with the enhanced SSL handshake protocol. In this case, the SSL session could be established yet the attribute certificate could still be rejected, thereby enabling the SSL session to continue to be used between the client and the server. In this alternative embodiment, an additional recovery procedure would be executed in which the server attempts to obtain the credential information from the client; in other words, the credential information could then be obtained after the establishment of the SSL session using the enhanced SSL handshake protocol while employing the recently established SSL session to securely transfer the credential information.

It should be noted that, in the exemplary embodiments of the present invention that are illustrated with respect to FIGS. 6-8, the creation of the attribute certificate occurs before the usage of the attribute certificate, i.e. well before the performance of the enhanced SSL handshake. In an alternative embodiment, though, the attribute certificate may be created during the enhanced SSL handshake, e.g., after the client receives the CERTIFICATE_REQUEST command from the server. However, in such embodiments, the attribute certificate would preferably be created entirely automatically in a programmatic manner without any pause for any type of user action or user input.

As noted above, in some cases, a user and a client device are recognized in the art as being entities that are sometimes interchangeable with respect to a perspective of the beneficiary of operations that are performed within data processing system. A natural person, such as the user of a client device, may be the Subject of a digital certificate, i.e. an entity whose identity is bound to a public key certificate as the named Subject of the public key certificate. However, a device, such as the client device, may also be the Subject whose identity is bound to a public key certificate. If the user of a client device is the entity with which the attribute information is associated, then the user's public key certificate is used to sign the attribute certificate; if the client device is the entity with which the attribute information is associated, then the client's public key certificate is used to sign the attribute certificate. In this manner, depending on the security operations that are performed by a server on behalf of a request from a client, which may be executing on behalf of a user or natural person, the present invention supports an enhanced SSL handshake in which credentials are transferred from a client to a server such that the credentials may be bound to, i.e. are associated with or are possessed by, a user or a client device.

It should also be noted that, in the exemplary embodiments of the present invention that are described above, only one attribute certificate is transferred from a client to a server. However, as noted above, attribute certificates may be created specifically for certain purposes, e.g., by placing the domain name of the intended recipient within the attribute certificate when it is created. Hence, in an alternative embodiment, multiple attribute certificates may be transferred from a client to a server during an enhanced SSL handshake; for example, multiple attribute certificates could be bundled together with the certificate chain that is transmitted. Each of the multiple attribute certificates would have been signed by the private key of the same public key certificate that is also transferred within the enhanced SSL handshake, and the client would be able to identify which attribute certificates of many available attribute certificates are required to be sent to a particular server by using the indicating information within the attribute certificates, such as the domain names. In this manner, the credential requirements of multiple server-side applications or operations can be fulfilled using the single stage authentication/authorization procedure that is embedded within the enhanced SSL handshake of the present invention. For example, if a client or a user needs to be logged into multiple server applications in order to effectively perform a set of tasks, then the credential information that is required by each of those multiple server applications could be transferred within the enhanced SSL handshake.

Alternatively, when an attribute certificate is generated, multiple sets of credential information may be bundled together within a single attribute certificate; the client and the server would possess corresponding logic for embedding or extracting the multiple sets of credential information. In this manner, a single attribute certificate could be used to transfer multiple sets of credentials, yet the credential needs of multiple server-side applications or operations can be fulfilled using the single stage procedure that is provided by the enhanced SSL handshake of the present invention.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for supporting establishment of a secure communication session within a data processing system, the method comprising:
sending a certificate request command from a server to a client;
receiving a certificate command at the server from the client in response to the certificate request command, wherein the certificate command is accompanied by a public key certificate and an attribute certificate that is digitally signed by a private key that is bound to the public key certificate, and wherein the attribute certificate contains credential information for an authentication operation or an authorization operation that is performed after establishment of the secure communication session; and
establishing the secure communication session in response to successfully verifying the public key certificate.

2. The method of claim 1 wherein the secure communication session is an SSL (Secure Sockets Layer) session.

3. The method of claim 2 further comprising:
passing the credential information from an SSL layer at the server to an application layer at the server after establishing the SSL session.

4. The method of claim 2 further comprising:
passing the attribute certificate from an SSL layer at the server to an application layer at the server after establishing the SSL session.

5. The method of claim 1 further comprising:
requiring a successful verification of the attribute certificate in addition to successful verification of the public key certificate prior to establishing the SSL session.

6. The method of claim 5 further comprising:
requiring a successful verification of the credential information in addition to successful verification of the public key certificate and the attribute certificate prior to establishing the SSL session.

7. The method of claim 1 further comprising:
decrypting the credential information by the server using a private key of the server, wherein the credential information was previously encrypted by the client using a public key that was received by the client from the server within a public key certificate prior to the client receiving the certificate request command.

8. The method of claim 1 wherein the secure communication session is a TSL (Transport Layer Security) session.

9. A method for supporting establishment of a secure communication session within a data processing system, the method comprising:
receiving a certificate request command at a client from a server;
sending a certificate command from the client to the server in response to the certificate request command, wherein the certificate command is accompanied by a public key certificate and an attribute certificate that is digitally signed by a private key that is bound to the public key certificate, and wherein the attribute certificate contains credential information for an authentication operation or an authorization operation that is performed after establishment of the secure communication session; and
receiving at the client from the server a notification that a secure communication session has been successfully established.

10. The method of claim 9 wherein the secure communication session is an SSL (Secure Sockets Layer) session.

11. The method of claim 9 wherein the secure communication session is a TSL (Transport Layer Security) session.

12. A computer program product on a computer readable medium for use within a data processing system for supporting establishment of a secure communication session, the computer program product comprising:
means for sending a certificate request command from a server to a client;
means for receiving a certificate command at the server from the client in response to the certificate request command, wherein the certificate command is accompanied by a public key certificate and an attribute certificate that is digitally signed by a private key that is bound to the public key certificate, and wherein the attribute certificate contains credential information for an authentication operation or an authorization operation that is performed after establishment of the secure communication session; and
means for establishing the secure communication session in response to successfully verifying the public key certificate.

13. The computer program product of claim 12 wherein the secure communication session is an SSL (Secure Sockets Layer) session.

14. The computer program product of claim 13 further comprising:
means for passing the credential information from an SSL layer at the server to an application layer at the server after establishing the SSL session.

15. The computer program product of claim 13 further comprising:
means for passing the attribute certificate from an SSL layer at the server to an application layer at the server after establishing the SSL session.

16. The computer program product of claim 12 further comprising:
means for requiring a successful verification of the attribute certificate in addition to successful verification of the public key certificate prior to establishing the SSL session.

17. The computer program product of claim 16 further comprising:
means for requiring a successful verification of the credential information in addition to successful verification of the public key certificate and the attribute certificate prior to establishing the SSL session.

18. The computer program product of claim 12 further comprising:
means for decrypting the credential information by the server using a private key of the server, wherein the credential information was previously encrypted by the client using a public key that was received by the client from the server within a public key certificate prior to the client receiving the certificate request command.

19. The computer program product of claim 12 wherein the secure communication session is a TSL (Transport Layer Security) session.

20. A computer program product on a computer readable medium for use within a data processing system for supporting establishment of a secure communication session, the computer program product comprising:
means for receiving a certificate request command at a client from a server;
means for sending a certificate command from the client to the server in response to the certificate request command, wherein the certificate command is accompanied by a public key certificate and an attribute certificate that is digitally signed by a private key that is bound to the public key certificate, and wherein the attribute certificate contains credential information for an authentication operation or an authorization operation that is performed after establishment of the secure communication session; and
means for receiving at the client from the server a notification that a secure communication session has been successfully established.

21. The computer program product of claim 20 wherein the secure communication session is an SSL (Secure Sockets Layer) session.

22. The computer program product of claim 20 wherein the secure communication session is a TSL (Transport Layer Security) session.

23. An apparatus for supporting establishment of a secure communication session within a data processing system, the apparatus comprising:
means for sending a certificate request command from a server to a client;
means for receiving a certificate command at the server from the client in response to the certificate request command, wherein the certificate command is accompanied by a public key certificate and an attribute certificate that is digitally signed by a private key that is bound to the public key certificate, and wherein the attribute certificate contains credential information for an authentication operation or an authorization operation that is performed after establishment of the secure communication session; and
means for establishing the secure communication session in response to successfully verifying the public key certificate.

24. The apparatus of claim 23 wherein the secure communication session is an SSL (Secure Sockets Layer) session.

25. The apparatus of claim 24 further comprising:
means for passing the credential information from an SSL layer at the server to an application layer at the server after establishing the SSL session.

26. The apparatus of claim 24 further comprising:
means for passing the attribute certificate from an SSL layer at the server to an application layer at the server after establishing the SSL session.

27. The apparatus of claim 23 further comprising:
means for requiring a successful verification of the attribute certificate in addition to successful verification of the public key certificate prior to establishing the SSL session.

28. The apparatus of claim 27 further comprising:
means for requiring a successful verification of the credential information in addition to successful verification of the public key certificate and the attribute certificate prior to establishing the SSL session.

29. The apparatus of claim 23 further comprising:
means for decrypting the credential information by the server using a private key of the server, wherein the credential information was previously encrypted by the client using a public key that was received by the client from the server within a public key certificate prior to the client receiving the certificate request command.

30. The apparatus of claim 23 wherein the secure communication session is a TSL (Transport Layer Security) session.

31. An apparatus for supporting establishment of a secure communication session within a data processing system, the apparatus comprising:
means for receiving a certificate request command at a client from a server;
means for sending a certificate command from the client to the server in response to the certificate request command, wherein the certificate command is accompanied by a public key certificate and an attribute certificate that is digitally signed by a private key that is bound to the public key certificate, and wherein the attribute certificate contains credential information for an authentication operation or an authorization operation that is performed after establishment of the secure communication session; and
means for receiving at the client from the server a notification that a secure communication session has been successfully established.

32. The apparatus of claim 31 wherein the secure communication session is an SSL (Secure Sockets Layer) session.

33. The apparatus of claim 31 wherein the secure communication session is a TSL (Transport Layer Security) session.
